(19) United States
(12) Patent Application Publication
(10) Pub. No.: US 2012/0056600 A1
(43) Pub. Date: Mar. 8, 2012

(54) CAPACITOR VEHICLE HAVING HIGH SPEED CHARGING ABILITY AND METHOD OF OPERATING A CAPACITOR VEHICLE

(76) Inventor: DONALD M. NEVIN, (US)

(21) Appl. No.: 13/079,146

(22) Filed: Apr. 4, 2011

Related U.S. Application Data
(60) Provisional application No. 61/402,692, filed on Sep. 3, 2010.

(51) Int. Cl. H02J 7/00

(52) U.S. Cl. 320/167; 320/166

(57) ABSTRACT

A vehicle is provided that includes a capacitor situated on the vehicle adapted to be charged by a source separate from the vehicle. The capacitor is adapted to be charged at a rate faster than a maximum charge rate of a battery of the vehicle. The vehicle also includes a charging circuit coupled to the capacitor and adapted to receive electrical charge from the capacitor and regulate the flow of electrical charge below the maximum charge rate of the battery. The vehicle also includes the battery coupled to the charging circuit and adapted to be charged by electrical charge flowing from the capacitor through the charging circuit, and an electric motor adapted to be energized by the battery to propel the vehicle. A method for operating a vehicle is provided that includes charging a capacitor arranged in the vehicle from a source separate from the vehicle.

### CROSS-REFERENCE TO RELATED APPLICATIONS

This application claims the benefit of U.S. Provisional Application No. 61/402,692 filed Sep. 3, 2010, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to electric vehicles, and in particular relates to a capacitor on a vehicle being rapidly charged by a capacitor at a charging station, and being used to charge a battery in the vehicle, where the battery is used for propulsion of the vehicle.

2. Description of Prior Art

Electric and hybrid vehicles are increasingly popular due to consumer's desires to reduce gas consumption. Electric vehicles typically use a battery or batteries to run an electric motor that drives the wheels. The battery may be recharged a small amount during braking, also referred to as regenerative braking. Batteries may also be charged at a wall outlet or a dedicated charging station. The future of electric vehicles is dependent on systems for rapidly charging the power supplies that they require. One disadvantage of battery powered electric vehicles is the slow charging time of the batteries. This is because the batteries charge by means of chemical reactions which require time to accomplish.

Electric vehicles may suffer from range problems that are not solved easily by recharging due to the slow recharging rate of batteries. Electric vehicles may be charged overnight in order to provide enough time to charge the vehicle. Alternative arrangements may provide for removing discharged batteries from a vehicle and installing charged batteries in the vehicle, and/or using higher voltages to reduce charging time.

Hybrid vehicles use a gas-powered engine to charge a battery, which in turn runs an electric motor. Hybrid vehicles may also have plug-in capability, in which case the battery may be charged by connecting the vehicle to a wall outlet, which may provide normal voltage or high voltage. U.S. Pat. No. 6,098,734 discusses a hybrid vehicle that uses a gas-powered engine to charge a capacitor, which in turn charges a battery.

Supercapacitors and ultracapacitors are capacitors having a high charge capacity. Capacitors have the ability to charge quickly, and when two capacitors are coupled, assuming their capacities are compatible, the two capacitors will quickly reach an equilibrium voltage. Supercapacitors may be able to be charged and discharged many more times than a battery.

The advantages of a supercapacitor include: a long life cycle, perhaps millions of cycles and/or a 10 to 12 year life; low impedance; fast charging; low risk of overcharging; very high rates of charge and discharge; and high cycle efficiency (perhaps 95% or more).

### BRIEF SUMMARY OF THE INVENTION

The present innovation discloses a faster charging system which encompasses a stationary charger, separate from the vehicle, which includes a supercapacitor attached to a stationary electrical supply, and an on-board capacitor and battery mounted in the electric vehicle.

The stationary supercapacitor of the charging station builds charge over time with the required circuitry and a connection to the electrical grid.

When a vehicle is attached to the stationary supercapacitor, the onboard capacitor or capacitors is connected to the stationary supercapacitor and a portion of the charge is rapidly transferred from the stationary supercapacitor to the onboard capacitor(s). For example if each capacitor were identical, one half of the charge would soon be present in the onboard capacitor and one half would remain in the stationary supercapacitor.

A further embodiment of the invention may allow for the user to select one or both of the onboard capacitor and the onboard battery to be charged at a stationary charging station, which may be of use when charging overnight. In this manner, the user can start the day with a full charge on both the battery and the capacitor. The electric motor could operate directly from charge on the capacitor until exhausted, or could run in a typical manner off the battery, with the capacitor being immediately available or in a short period thereafter to maintain a full charge of the battery until the capacitor is exhausted.

As soon as adequate charge has been transferred to the onboard supercapacitor, the vehicle may be detached from the wall charger. The onboard capacitor will continuously allow charging of the battery (the capacitor acts as a charge reservoir) while the vehicle is in motion.

In this manner it is possible to reduce the required charging times for battery powered electric vehicles. The present invention may be used for any vehicles, including automotive, military, uav (unmanned, autonomous vehicles), and/or boats. Charging stations may use the electric grid, and/or alternatively or additionally solar and wind generation systems.

A vehicle is provided that includes a capacitor situated on the vehicle adapted to be charged by a source separate from the vehicle. The capacitor is adapted to be charged at a rate faster than a maximum charge rate of a battery of the vehicle. The vehicle also includes a charging circuit coupled to the capacitor and adapted to receive electrical charge from the capacitor and regulate the flow of electrical charge below the maximum charge rate of the battery. The vehicle further includes the battery coupled to the charging circuit and adapted to be charged by electrical charge flowing from the capacitor through the charging circuit, and an electric motor adapted to be energized by the battery to propel the vehicle.

In the vehicle, the source separate from the vehicle may be a second capacitor at a charging station, and the capacitor is charged by the second capacitor by a low resistance electric coupling.

In the vehicle, the electric motor may be further adapted to be energized by the capacitor to propel the vehicle. The capacitor may be a capacitor, a supercapacitor or an ultracapacitor. The battery may be adapted to be charged by electrical charge flowing from the capacitor through the charging circuit after the capacitor is charged by the separate source.

The capacity of the capacitor may exceed 20, 30, 40, 50, 60, 70, 80, or 90 percent of a second capacity of the battery.

A method for operating a vehicle is provided that includes charging a capacitor arranged in the vehicle from a source separate from the vehicle. The capacitor is charged at a rate faster than a maximum charge rate of a battery of the vehicle. The method also includes charging the battery arranged in the vehicle from the capacitor via a charging circuit coupled to the capacitor. The charging circuit is adapted to receive electrical charge from the capacitor and limit the flow of electrical charge below the maximum charge rate of the battery. The method further includes energizing an electric motor arranged in the vehicle from the battery to propel the vehicle.

The method may include, before charging the capacitor arranged in the vehicle from the source separate from the vehicle, electrically coupling the capacitor in the vehicle to the source separate from the vehicle.

The method may include, after charging the capacitor arranged in the vehicle from the source separate from the vehicle, decoupling the capacitor in the vehicle to the source separate from the vehicle.

In the method, the source separate from the vehicle may be a second capacitor at a charging station, and the capacitor may be charged by the second capacitor by a low resistance electric coupling.

The method may further include energizing the electric motor directly by the capacitor to propel the vehicle. The operation of charging the battery may be performed after the operation of charging the capacitor is complete.

### BRIEF DESCRIPTION OF THE DRAWINGS

FIG. 1 is a diagrammatic view of an exemplary vehicle according to the present invention;

FIG. 2 is a diagrammatic view of an exemplary system according to the present invention for charging the exemplary vehicle of FIG. 1;

FIG. 3 is a flow chart illustrating an exemplary method according to the present invention; and

FIG. 4 illustrates a computer system according to an exemplary embodiment according to the present invention.

### DETAILED DESCRIPTION OF THE INVENTION

In the following description, electric vehicles refer to pure electric vehicles, hybrid vehicles, and/or any vehicle using a battery for some or all of the propulsion of the vehicle.

A large capacity capacitor is installed in a vehicle and adapted to charge a battery in the vehicle through a charging circuit. The charging circuit limits the flow of electricity to the battery to below a maximum charge rate of the battery. The battery stores the electrical energy and drives an electric motor to propel the vehicle.

A capacitor on a vehicle may be quickly charged by a capacitor at a charging station, thereby enabling electric vehicles to increase their range and utility. The charging station may have a similar-sized capacitor that may be electrically coupled to the vehicle's capacitor. The charging station's capacitor may be charged prior to connection to the vehicle capacitor to a charge level selected to cause the charge of the vehicle capacitor to approach without exceeding a maximum charge capacity of the vehicle capacitor. After charging the vehicle capacitor and decoupling the vehicle, the charging station capacitor may be recharged slowly from the electrical grid.

The capacitor may discharge, after charging and/or after decoupling from the charging station's capacitor, through a charging circuit that limits the flow of electricity, to a battery that is capable of holding a charge for an extended period of time without significant loss of charge. The battery may in turn be used to propel the vehicle.

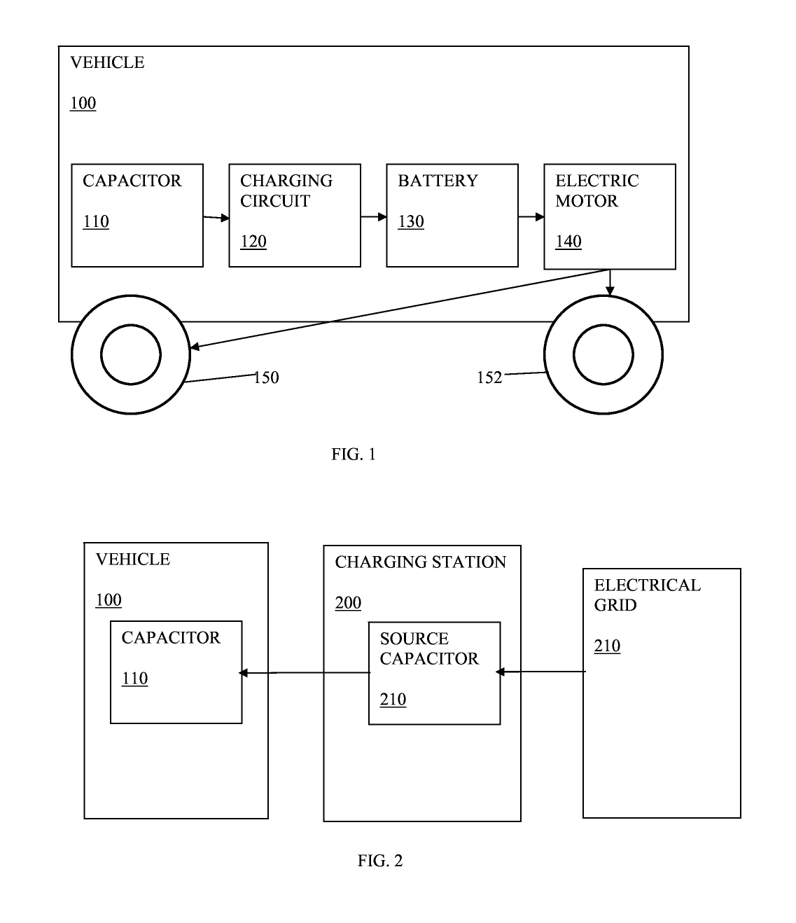

FIG. 1 is a diagrammatic view of vehicle 100. Vehicle 100 includes capacitor 110 coupled to charging circuit 120. Charging circuit 120 is also coupled to battery 130. Charging circuit 120 operates to limit the flow of electricity to battery 130 from capacitor 110 to prevent damage to battery 130. Battery 130 has a maximum charge rate above which damage to battery 130 may be caused, and/or electrical charge may be lost. The maximum charge rate may be dependent on the chemical processes occurring within battery 130, and may also be temperature dependent. Charging circuit 120 may include a temperature sensor, and may adjust the maximum charge rate based on the temperature reading.

Battery 130 is coupled to electric motor 140 which operates to drive wheels 150, 152 to propel vehicle 100. Battery 130 may also be charged by a plug-in system directly, for instance while parked overnight. Additionally or alternatively, battery 130 may also be charged by a gas-powered generator, solar cells, or any other appropriate method. The electrical capacity of capacitor 110 and battery 130 may be matched so that a fully charged capacitor 110 is able to fully charge battery 130.

Additionally, capacitor 110 may be able to drive electric motor 140 directly, or through another charging circuit, without the flow of electricity flowing through battery 130. In this manner, battery 130 may operate to store electricity for longer periods, while capacitor 110 may operate to drive electric motor 140 immediately after charging capacitor 110.

Additionally, capacitor 110 may be two or more capacitors, which may be connected to a single charging circuit 120 or which may each have their own charging circuit. Likewise, battery 130 may include two or more batteries connected in parallel or series.

FIG. 2 is a diagrammatic view of an exemplary system for charging vehicle 100. Vehicle 100 may stop at charging station 200 when the charge in battery 130 and/or capacitor 110 is low. Vehicle 100 may be electrically coupled to source capacitor 210 of charging station 200 by an electrical cord or by any other appropriate method. Providing a low-resistance electrical coupling between capacitor 110 in vehicle 100 and source capacitor 210 at charging station 200 may allow the fast charging of capacitor 110. Source capacitor 210 and capacitor 110 may quickly arrive at an equilibrium voltage after electrically coupling the two capacitors. In this manner, capacitor 110 is quickly charged. Source capacitor 210 may have a total capacity that is sized to maximize the total charge of capacitor 110 after coupling the two capacitors, and to avoid damaging capacitor 110. After charging capacitor 110, the coupling between capacitor 110 and source capacitor 210 may be removed and vehicle 100 may continue driving. Electric motor 140 of vehicle 100 may initially drive off charge from capacitor 110, while capacitor 110 also slowly charges battery 130 via charging circuit 120.

Source capacitor 210 of charging station 200 may be slowly charged off electrical grid 220 after vehicle 100 has decoupled from source capacitor 210.

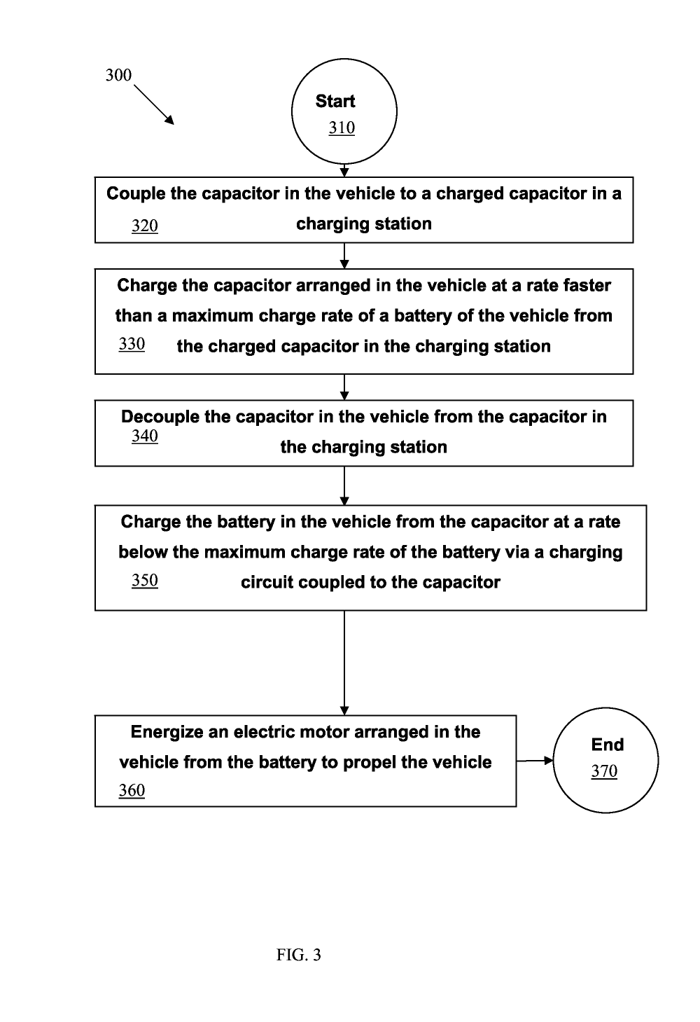

FIG. 3 illustrates method 300 according to an exemplary embodiment. Method 300 starts at start circle 310 and proceeds to operation 320, which indicates to couple the capacitor in the vehicle to a charged capacitor in a charging station. From operation 320 the flow in method 300 proceeds to operation 330, which indicates charge the capacitor arranged in the vehicle at a rate faster than a maximum charge rate of a battery of the vehicle from the charged capacitor in the charging station. From operation 330 the flow in method 300 proceeds to operation 340, which indicates to decouple the capacitor in the vehicle from the capacitor in the charging station. From operation 340 the flow in method 300 proceeds to operation 350, which indicates to charge the battery in the vehicle from the capacitor at a rate below the maximum charge rate of the battery via a charging circuit coupled to the capacitor. From operation 350 the flow in method 300 proceeds to operation 360, which indicates to energize an electric motor arranged in the vehicle from the battery to propel the vehicle. From operation 360 the flow in method 300 proceeds to end circle 370.

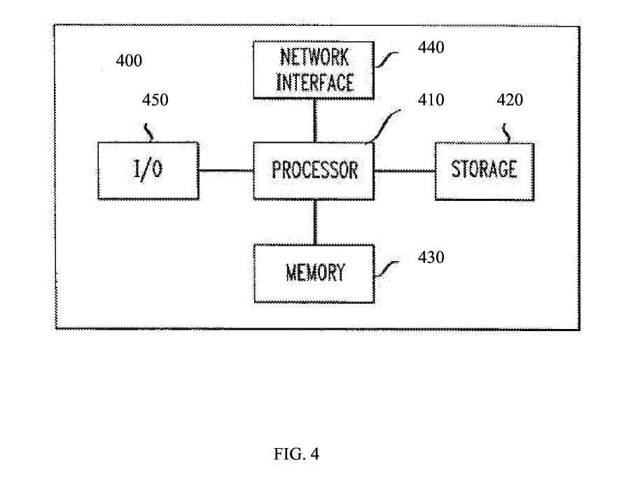

FIG. 4 illustrates a computer system according to an exemplary embodiment. Computer 400 can, for example, operate or control charging circuit 120 and/or electric motor 140, or may control the recharging of source capacitor 210 from electrical grid 220. Additionally, computer 400 can perform the steps described above (e.g., with respect to FIG. 3). Computer 400 contains processor 410 which controls the operation of computer 400 by executing computer program instructions which define such operation, and which may be stored on a computer-readable recording medium. The computer program instructions may be stored in storage 420 (e.g., a magnetic disk, a database) and loaded into memory 430 when execution of the computer program instructions is desired. Thus, the computer operation will be defined by computer program instructions stored in memory 430 and/or storage 420 and computer 400 will be controlled by processor 410 executing the computer program instructions. Computer 400 also includes one or more network interfaces 440 for communicating with other devices, for example other computers, servers, or websites. Network interface 440 may, for example, be a local network, a wireless network, an intranet, or the Internet. Computer 400 also includes input/output 450, which represents devices which allow for user interaction with the computer 400 (e.g., display, keyboard, mouse, speakers, buttons, webcams, etc.). One skilled in the art will recognize that an implementation of an actual computer will contain other components as well, and that FIG. 4 is a high level representation of some of the components of such a computer for illustrative purposes.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A vehicle having a battery with a maximum charging rate, comprising:
a capacitor situated on said vehicle adapted to be charged by an electrical source separate from said vehicle, said capacitor being adapted to be charged at a rate faster than said maximum charge rate of said vehicle battery;
a charging circuit coupled to said capacitor and adapted to receive electrical charge from said capacitor and to regulate said flow of electrical charge to said capacitor below said maximum charge rate of said vehicle battery, said charging circuit being connected to said vehicle battery, said vehicle battery being adapted to be charged by electrical charge flowing from said capacitor through said charging circuit; and
an electric motor adapted to be energized by said vehicle battery to propel said vehicle.

2. The vehicle of claim 1, further comprising a low resistance electric coupler connected to said capacitor and adapted to be connected to a second low resistance electric coupler of said electrical source during a charging operation;
wherein said electrical source comprises a second capacitor at a charging station; and
wherein said capacitor is charged by said second capacitor by said low resistance electric coupler being connected to said second low resistance electric coupler during said charging operation.

3. The vehicle of claim 1, wherein said electric motor is further adapted to be energized directly by said capacitor to propel said vehicle.

4. The vehicle of claim 1, wherein said capacitor is one of a supercapacitor and an ultracapacitor.

5. The vehicle of claim 1, wherein said battery is adapted to be charged by electrical charge flowing from said capacitor through said charging circuit after said capacitor is charged by said separate source.

6. The vehicle of claim 1, wherein said capacity of said capacitor exceeds 20 percent of a second capacity of said battery.

7. The vehicle of claim 1, wherein said capacity of said capacitor exceeds 50 percent of a second capacity of said battery.

8. The vehicle of claim 1, wherein said capacity of said capacitor exceeds 80 percent of a second capacity of said battery.

9. A vehicle comprising:
a capacitor situated on the vehicle adapted to be charged by a source separate from the vehicle, the capacitor being adapted to be charged at a rate faster than a maximum charge rate of a battery of the vehicle;
a charging circuit coupled to the capacitor and adapted to receive electrical charge from the capacitor and to limit the flow of electrical charge below the maximum charge rate of the battery;
the battery coupled to the charging circuit and adapted to be charged by electrical charge flowing from the capacitor through the charging circuit; and
an electric motor adapted to be energized by the battery to propel the vehicle.

10. The vehicle of claim 9, further comprising a low resistance electric coupler connected to the capacitor and adapted to be connected to a second low resistance electric coupler of said electrical source during a charging operation;
wherein the electrical source comprises a second capacitor at a charging station;
wherein the capacitor is charged by the second capacitor by the low resistance electric coupler being connected to the second low resistance electric coupler during the charging operation; and
wherein the battery is adapted to be charged by electrical charge flowing from the capacitor through the charging circuit after the capacitor is charged by the electrical source.

11. A method for operating a vehicle having a capacitor, a battery with a maximum charging rate, and a charging circuit coupling said capacitor and said battery, comprising:
charging said capacitor arranged in said vehicle from a source separate from said vehicle, said capacitor being charged at a rate faster than said maximum charge rate of said battery of said vehicle;
charging said battery in said vehicle from said capacitor through said charging circuit coupled to said capacitor, said charging circuit being adapted to receive electrical charge from said capacitor and to limit said flow of electrical charge to said battery to be below said maximum charge rate of said battery; and
energizing an electric motor in said vehicle from said battery to propel said vehicle.

12. The method of claim 11, further comprising, before charging said capacitor arranged in said vehicle from said source separate from said vehicle, electrically coupling said capacitor in said vehicle to said source separate from said vehicle.

13. The method of claim 11, further comprising, after charging said capacitor arranged in said vehicle from said source separate from said vehicle, decoupling said capacitor in said vehicle to said source separate from said vehicle.

14. The method of claim 11, wherein:
said source separate from said vehicle is a second capacitor at a charging station; and
said capacitor is charged by said second capacitor by a low resistance electric coupling.

15. The method of claim 11, further comprising energizing said electric motor directly by said capacitor to propel said vehicle.

16. The method of claim 11, wherein said capacitor is one of a supercapacitor and an ultracapacitor.

17. The method of claim 11, wherein said operation of charging said battery is performed after said operation of charging said capacitor is complete.

18. The method of claim 11, wherein said capacity of said capacitor exceeds 20 percent of a second capacity of said battery.

19. The method of claim 11, wherein said capacity of said capacitor exceeds 50 percent of a second capacity of said battery.

20. The method of claim 11, wherein said capacity of said capacitor exceeds 80 percent of a second capacity of said battery.
